(19) United States
(12) Patent Application Publication
(10) Pub. No.: US 2005/0006369 A1
(43) Pub. Date: Jan. 13, 2005

(54) Vehicle steering wheel with heating element

(75) Inventor: Martin Kreuzer, Kleinwallstadt (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/869,686

(22) Filed: Jun. 16, 2004

(30) Foreign Application Priority Data
Jul. 11, 2003 (DE) 203 10 682.2

(51) Int. Cl. H05B 3/16; B60L 1/02

(52) U.S. Cl. 219/204; 219/543

(57) ABSTRACT

A vehicle steering wheel comprises an outer skin, a steering wheel rim and an integrated heating element. The heating element is a large-surface, multi-layered, thin composite component, located under the outer skin. The heating element has a first conducting layer, a second conducting layer and an electrically conductive heating layer located between the conducting layers. The first extensive conducting layer extends innermost, viewed in radial cross-section through the steering wheel rim. The heating layer adjoins externally the first conductive layer over a large surface, and the conducting layer adjoins the outside of the heating layer over a large surface.

### TECHNICAL FIELD

This invention relates to a vehicle steering wheel, comprising an outer skin, a steering wheel rim and an integrated heating element.

### BACKGROUND OF THE INVENTION

DE 297 12 839 U1 shows an electrically conductive plastic layer injection molded around a vehicle steering wheel. The plastic layer is interrupted at one site radially by an insulating strip and is contacted on both sides of the insulating strip. Thus it is possible to send an electric current through the plastic layer for heating thereof, this current flowing through the entire periphery of the steering wheel rim, in relation to the rotation axis. Owing to the relatively high specific resistance of the plastic layer and the length of the conducting distance of over one meter, a comparatively high voltage must be applied to the contacts, in order to achieve a sufficient heating output.

It is an object of the invention to provide a vehicle steering wheel with a heating element which can be produced simply and at a favorable cost and offers a uniform heating output on controlling with low voltage.

According to the invention, a vehicle steering wheel, comprises an outer skin, a steering wheel rim and an integrated heating element, the heating element being an extensive (i.e. large-surface), multi-layered, thin composite component, comprising a first conducting layer, a second conducting layer and an electrically conductive heating layer being located between the first conducting layer and the second conducting layer. The heating element is located under the outer skin, the first large-surface conducting layer, extending innermost viewed in a radial cross-section through the steering wheel rim, the heating layer extensively adjoining externally the first conductive layer, i.e. over a large surface, the second conducting layer extensively adjoining the outside of the heating layer, i.e. also over a large surface. In this way, a short current flow path is provided and hence a low absolute resistance at which, with low voltage, a high heating performance can be achieved. In addition, a uniform current flow and therefore a uniform heating of the heating layer is ensured by the large contact surfaces, compared to the cross-sectional area. The radial cross-section is a section along a plane in which the steering wheel axis lies.

According to a preferred embodiment of the invention, an elastomer constitutes the heating layer. Thus, the heating element can serve as part of the elastic casing of the vehicle steering wheel.

According to another advantageous embodiment of the invention, at least one of the conductive layers is constituted by a vaporized metal layer. This metal layer can be very thin, for example 50 μm, resulting in a reduced weight of the heating element and also in a saving of contact material for the conductive layers.

Further advantageous embodiments will be apparent from the sub-claims.

### BRIEF DESCRIPTION OF THE DRAWINGS

FIG. 1 shows a radial cross-section through a vehicle steering wheel according to the invention; and

FIG. 2 shows an enlarged cut-out of the region II in FIG. 1.

### DETAILED DESCRIPTION OF THE PREFERRED EMBODIMENTS

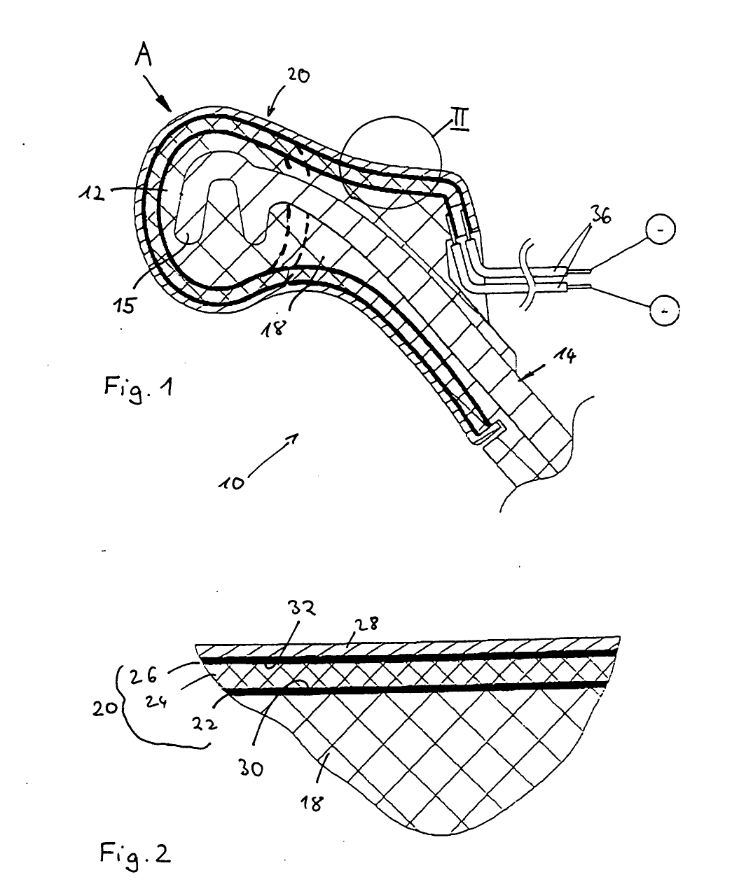

In FIG. 1, there is illustrated in a cross-section a part of a vehicle steering wheel 10 with a steering wheel rim 12 and a spoke 14. The vehicle steering wheel 10 is constructed from a steering wheel skeleton 15, for example of steel, which as usual is foamed around by a padding 18 made of a plastic. In the region of the steering wheel rim 12 and reaching partially over the spokes 14, the padding 18 is surrounded by a thin, extensive and large-surface heating element, which is constructed as a composite component.

The heating element 20 is constructed in the manner of a sandwich from several layers, the sequence of which can be clearly seen in cross-section through the steering wheel rim 12 and the spoke 14 in FIG. 2. Viewing radially inwards (see arrow A) in cross-section through the steering wheel rim 12, an extensive, sheet-like or foil-like, large-surface first conducting layer 22 of material with good conductivity is located directly on the padding 18. An electrically conductive heating layer 24, is adjoining the first conducting layer 22 towards the exterior, covering the full area of the first conducting layer 22. An extensive, sheet-like or foil-like, large-surface second conducting layer 26 is adjoining the electrically conductive heating layer 24 externally. A covering layer, for example of leather, forms an outer skin 28, so that the heating element 20 is arranged directly under the outer skin 28.

Viewed in cross-section through the steering wheel rim 12, the heating element 20 runs as a ring segment under the outer skin 28. As indicated in FIG. 1 by the dashed lines, the heating element 20 surrounds the steering wheel rim beyond the sections where the steering wheel rim 12 is connected with a spoke 14, as an at least approximately closed ring.

The heating layer 24 a first contact surface 30 adjoining the first conducting layer 22 and an opposite second contact surface 32 adjoining the second conducting layer 26. In the embodiment shown, the heating layer 24 extends over the entire periphery of the steering wheel, the conducting layers 22 and 26 almost completely covering the two contact surfaces 30, 32 of the heating layer 24. The areas of the contact surfaces 30, 32 are therefore large compared to the cross-sectional area Q of the heating layer 24.

In the region of the spoke 14, the conducting layers 22, 26 are contacted with connecting wires 36, through which a heating current I_{H} can be supplied to the heating element 20.

The heating layer 24 consists of an electrically conductive plastic, preferably based on silicon, rubber or other castable elastomers. Thereby, a haptic impression is retained, which is familiar to the user of the vehicle steering wheel 10 from elastically foam-surrounded steering wheels. The thickness of the heating layer 24 preferably amounts to 0.5 to 2.5 mm and is selected so that the desired heating performance can be achieved as a function of the specific resistance of the conductive plastic and the size of the contact areas 30, 32.

For the conducting layers 22, 26, preferably foils of aluminium, copper or other conductive alloys are provided. The thickness of these foils is adapted to the conductivity of the heating layer 24 and preferably amounts to 0.1 to 0.3 mm.

As the conducting layers 22, 26 have a substantially higher conductivity than the heating layer 24 with a typical resistance of approximately 3 to 4 Ohm, the conducting layers 22, 26 are merely to be understood as electrical leads. The heating by the supplied heating current I_{H} performs substantially within the heating layer 24.

According to an alternative embodiment, the heating element 20 does not extend over the entire steering wheel rim 12, but rather only over regions where a heating is desired.

According to another embodiment, alternatively one or both conductive layers 22, 26 can be constructed as a sprayed-on or vaporized metal layer. In this case, a substantially smaller thickness of the conducting layers 22, 26 of for example 50 μm has proved to be sufficient. This has the advantage of a lesser impairment to the elastic resilience of the steering wheel. In addition, savings on weight and material result from the thinner conducting layers.

For the production of the vehicle steering wheel 10 according to the invention, the steering wheel skeleton, which is foam-surrounded with the padding 18, is covered with the first conducting layer 22, for example in the form of a metal foil, in regions where heating is desired, i.e. in the regions of the steering wheel rim 12 and the adjoining section of the spokes 14. The first conducting layer 22 is then cast around with the conducting elastomer, which forms the heating layer 24. Then the heating layer 24 is surrounded by the second conducting layer, which may again be a metal foil. Finally, the steering wheel is leather covered with the covering layer, which forms the outer skin 28, as is sufficiently known from the prior art.

An alternative production method is based on the fact that the layers of the heating element 20 are not applied individually onto the steering wheel. In this method, the separate components are initially applied, for example glued, onto the blank of the covering layer. Then the covering layer with the complete heating element 20 is fastened to the steering wheel skeleton in a conventional manner, for example glued or sewn. This has the advantage that the entire heavy steering wheel skeleton does not have to be handled while assembling the heating element 20.

1. A vehicle steering wheel, comprising an outer skin, a steering wheel rim and an integrated heating element, said heating element being a large-surface, multi-layered, thin composite component comprising a first conducting layer, a second conducting layer and an electrically conductive heating layer being located between said first conducting layer and said second conducting layer, said heating element being located under said outer skin, said first extensive conducting layer extending innermost viewed in a radial cross-section through said steering wheel rim, said heating layer adjoining externally said first conductive layer over a large-surface, said second, conducting layer adjoining an outside of said heating layer over a large surface.

2. The vehicle steering wheel according to claim 1, wherein said heating element is arranged directly underneath said outer skin.

3. The vehicle steering wheel according to claim 1, wherein said heating element, viewed in a radial cross-section through the steering wheel rim, extends under said outer skin, forming a ring segment.

4. The vehicle steering wheel according to claim 1, wherein said steering wheel has at least one spoke, said spoke being connected to said steering wheel rim in a section of said rim, said heating element surrounding said steering wheel rim beyond said section as an at least approximately closed ring, viewed in a radial cross-section through the steering wheel rim.

5. The vehicle steering wheel according to claim 1, wherein an elastomer constitutes said heating layer.

6. The vehicle steering wheel according to claim 1, wherein at least one of said conducting layers is constituted by an electrically conducting foil.

7. The vehicle steering wheel according to claim 1, wherein at least one of the conducting layers is constituted by a vaporized metal layer.
